(19) United States
(12) Patent Application Publication
(10) Pub. No.: US 2013/0206905 A1
(43) Pub. Date: Aug. 15, 2013

(54) INTEGRATED GALLEY AND BIN MONUMENT

(71) Applicant: C&D ZODIAC, INC., (US)

(72) Inventors: Scott Savian, Huntington Beach, CA (US); Kyle Gee, Los Angeles, CA (US)

(73) Assignee: C&D ZODIAC, INC., Huntington Beach, CA (US)

(21) Appl. No.: 13/765,528

(22) Filed: Feb. 12, 2013

Related U.S. Application Data
(60) Provisional application No. 61/598,797, filed on Feb. 14, 2012.

(51) Int. Cl. B64D 11/04; B64F 5/00

(52) U.S. Cl. CPC B64D 11/04; B64F 5/0009
USPC 244/118.5; 29/428

(57) ABSTRACT

A galley monument assembly that is configured to be positioned in the interior of an aircraft. The galley monument assembly includes a lower storage section that is adapted to receive at least one trolley cart and that includes a vertically oriented rear wall and two opposing side walls. The lower storage section defines a first storage depth. The galley monument assembly also includes an upper storage section that defines a second storage depth. The second storage depth is deeper than the first storage depth.

### CROSS REFERENCE TO RELATED APPLICATIONS

This application claims the benefit of U.S. Provisional Application No. 61/598,797, filed Feb. 14, 2012, which is herein incorporated by reference in its entirety.

### FIELD OF THE INVENTION

The present invention relates generally to aircraft galley monuments and more particularly to an aircraft galley monument that is integrated with an overhead stowage bin.

### BACKGROUND OF THE INVENTION

Commercial aircraft, such as the Airbus A320 or Boeing 737 are typically constructed from modular components, the size, weight and construction of which are dictated by many considerations; including fuselage dimensions, aesthetics and safety. Many of these requirements are imposed by law or regulation. Aircraft components, such as overhead stowage compartments, seats, lavatories, galleys, lighting systems, etc. are all required to function within strictly confined spaces.

Manufacturers of aircraft are constantly refining interior aircraft designs to achieve more comfort and utility for passengers and crew within carrier-imposed restraints on cost, weight, maintenance down-time, and safety. Commercial passenger aircraft generally include galleys for use by the crew for storing food and the like.

Galley monuments on commercial aircraft have traditionally had rectangular footprints and included vertical wall geometries. In the prior art, space allocated for the galley is separated from the space allocated for overhead stowage compartments. For this reason, galley monuments in the constant and tapering sections of commercial airplanes are either unable to accommodate many standard units, or they are volumetrically large.

### SUMMARY OF THE PREFERRED EMBODIMENTS

In accordance with a first aspect of the present invention there is provided a galley monument assembly that is configured to be positioned in the interior of an aircraft. The galley monument assembly includes a lower storage section that is adapted to receive at least one trolley cart and that includes a vertically oriented rear wall and two opposing side walls. The lower storage section defines a first storage depth. The galley monument assembly also includes an upper storage section that defines a second storage depth. The second storage depth is deeper than the first storage depth. In a preferred embodiment, the galley monument assembly includes a floor footprint that defines a depth that is less than the depth of the upper storage section. In a preferred embodiment, the galley monument assembly includes a transition section disposed between the lower storage section and the upper storage section that defines a gradually increasing storage depth. The gradually increasing storage depth is greater than the depth of the floor footprint. Preferably, the galley monument assembly includes an overhanging portion that defines at least a portion of the upper storage sec (and that includes a rear wall that has a contoured inboard edge. When the galley monument assembly is positioned in the interior of an aircraft the rear wall abuts a wall of an overhead stowage bin and the contoured inboard edge has approximately the same shape as an inboard edge of the wall of the overhead stowage bin. Preferably, the galley monument assembly includes a work surface that separates the lower storage area and the transition section.

In accordance with another aspect of the present invention there is provided an aircraft that includes a cabin having an interior side wall, at least a first overhead stowage bin having an end wall and that is attached to the interior side wall, and a galley monument assembly positioned within the cabin. The galley monument assembly includes a lower storage section that is adapted to receive at least one trolley cart, that includes a vertically oriented rear wall and two opposing side walls and defines a first storage depth. The upper storage section defines a second storage depth that is deeper than the first storage depth. The upper storage section includes a rear wall that abuts the end wall of the first overhead stowage bin. In a preferred embodiment, the aircraft includes at least one seat positioned adjacent the rear wall of the lower storage section of the galley monument. The seat includes a seat portion and a back portion. At least a portion of the upper storage section is positioned vertically above one or both of the back portion or the seat portion. In a preferred embodiment, the galley monument assembly includes an overhanging portion that at least partially defines the upper storage section and that includes a rear wall that has a contoured inboard edge with a shape. The end wall of the first overhead storage bin has an inboard edge with a shape, and the contoured inboard edge has approximately the same shape as the inboard edge of the end wall of the overhead stowage bin. Preferably, the galley monument assembly includes a floor footprint that defines a depth and the depth of the upper storage section and the gradually increasing storage depth are greater than the depth of the floor footprint.

In accordance with another aspect of the present invention there is provided a method that includes positioning within the cabin of an aircraft at least a first overhead stowage bin having an end wall and positioning within the cabin of the aircraft a galley monument assembly that includes a lower storage section that is adapted to receive at least one trolley cart and that includes a vertically oriented rear wall and two opposing side walls. The lower storage sec (defines a first storage depth. The galley monument assembly also includes an upper storage section that defines a second storage depth and that includes at least a first compartment having a front opening. The second storage depth is deeper than the first storage depth, and the upper storage section includes a rear wall that abuts the end wall of the first overhead stowage bin. The method further includes positioning at least one seat adjacent the rear wall of the lower storage section of the galley monument. The seat includes a seat portion and a back portion and at least a portion of the upper storage section is positioned vertically above one or both of the back portion or the seat portion. The method also includes placing a first object into the upper storage section through the front opening of the first compartment, and pushing the object through the first compartment to a position where it is located vertically above one or both of the back portion or the seat portion. In a preferred embodiment, the galley monument assembly includes a transition section disposed between the lower storage section and the upper storage section that defines a gradually increasing storage depth and includes at least a second compartment having a front opening. The method preferably includes placing a second object into the transition section through the front opening of the second compartment, and pushing the object through the second compartment to a position where it is located deeper than the first storage depth.

### BRIEF DESCRIPTION OF THE DRAWINGS

FIG. 1 is a perspective view of a galley monument assembly in accordance with a preferred embodiment of the present invention secured to a fixed overhead stowage bin;

FIG. 2 is a perspective view of the galley monument assembly of FIG. 1 secured to an overhead pivot bin;

FIG. 3 is a perspective view of the galley monument assembly of FIG. 1;

FIG. 4 is a front devotional view of the galley monument assembly of FIG. 1;

FIG. 5 is a side elevational view of another preferred embodiment of a galley monument assembly; and

FIG. 6 is a perspective view of the galley monument assembly of FIG. 5;

FIG. 7 is a perspective view of the galley monument assembly of FIG. 5;

FIG. 8 is another perspective view of the galley monument assembly of FIG. 5;

FIG. 9 is a bottom plan view of the galley monument assembly of FIG. 5;

FIG. 10 is an devotional view of the galley monument of FIG. 5 in cross-section; and

FIG. 11 is a schematic plan view of a portion of an aircraft with two galley monument assemblies in an aft section thereof.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments.

Reference in this specification to “one embodiment” or “an embodiment” means that a particular feature, structure, or characteristic described in connection with the embodiment is included in at least one embodiment of the-disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

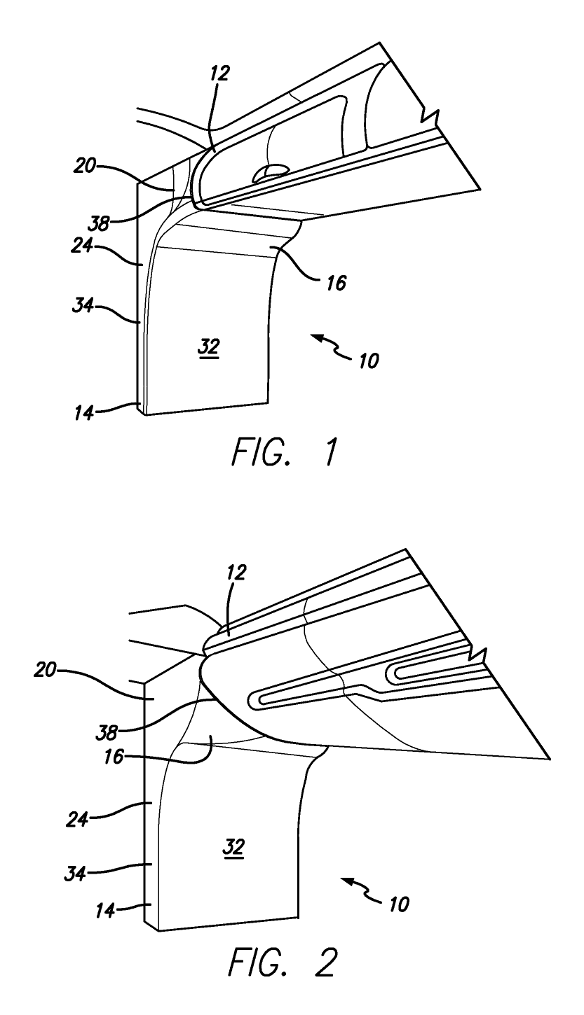

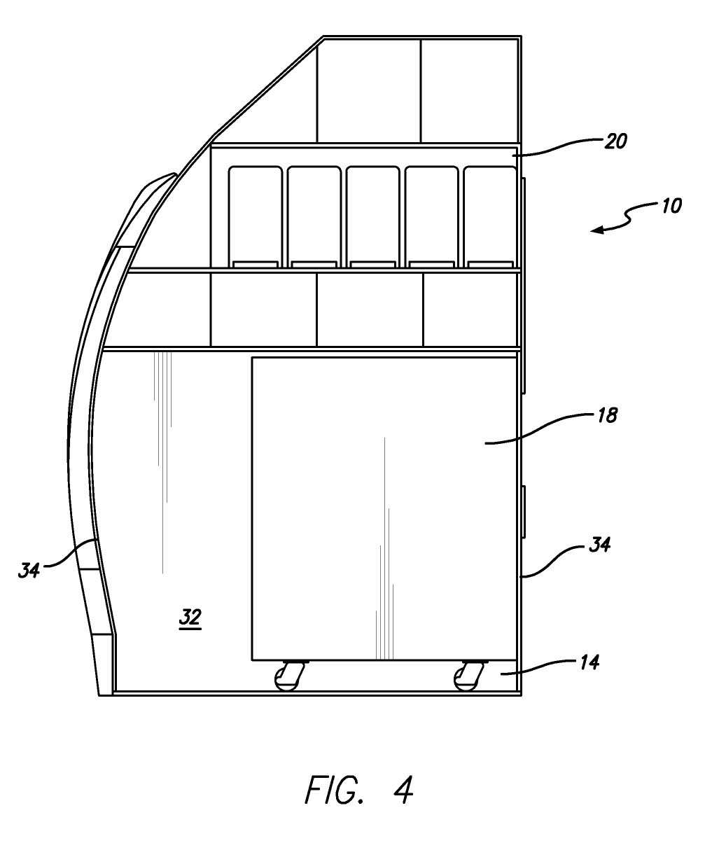

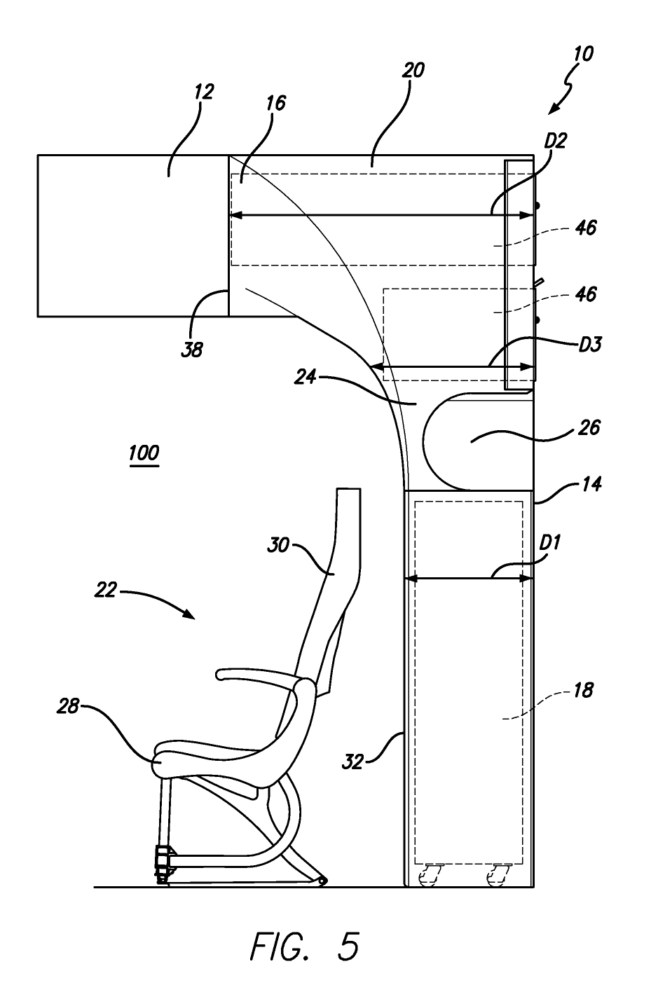

Referring now to the drawings, wherein the showings are for purposes of illustrating the present invention and not for purposes of limiting the same, FIGS. 1-11 show embodiments of a galley monument assembly 10 that is integrated with or secured to an overhead stowage bin 12. In particular, the invention can be used on commercial passenger aircraft. However, this is not a limitation on the present invention and the galley monument assembly 10 can be used elsewhere. FIGS. 1-4 show a first embodiment of a galley monument assembly 10 adapted to be positioned on the right side and in the aft section of an aircraft cabin 100 and FIGS. 5-10 show a second embodiment of a galley monument assembly 10 adapted to be positioned on the left side and in the aft section of an aircraft cabin. The galley monument assembly 10 can also be positioned or installed in the front or mid section of the cabin 100 as desired.

As will be appreciated by those skilled in the art, within the cabin 100 of an aircraft 102, monuments are typically secured to attachment points, such as hard points and overhead and side attachments. Accordingly, a description of the attachment of the galley monument assembly will be omitted.

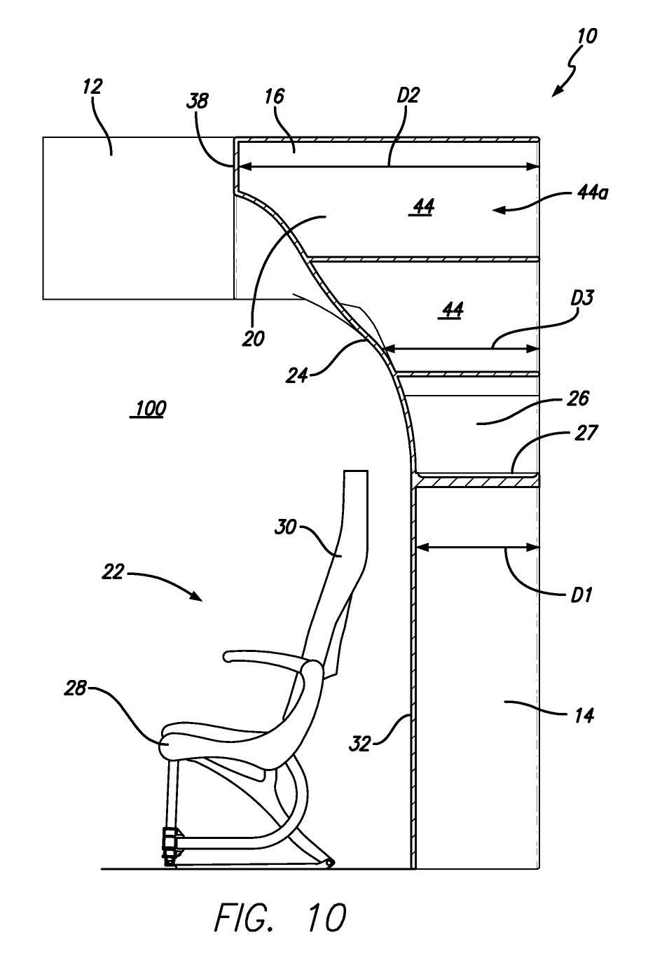

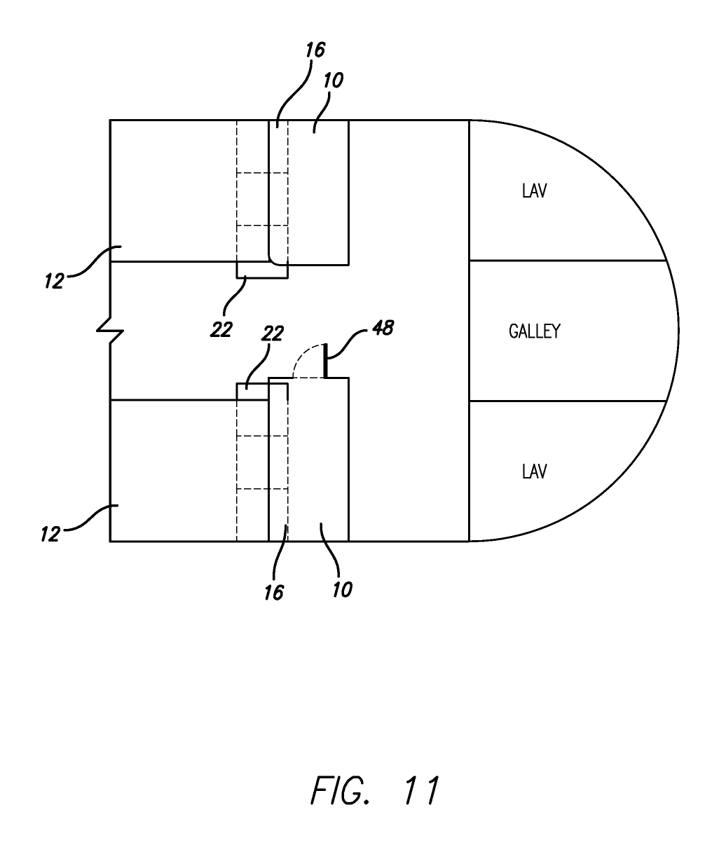

In a preferred embodiment, the galley monument assembly 10 utilizes a portion of what is typically used for overhead stowage compartment or bin space. In other words, it the galley monument assembly 10 was retrofitted into an existing aircraft, a bin (or more than or part of one) would be removed to make room for the overhanging portion 16 of the upper storage section 20 (discussed below). Preferably, the galley monument assembly 10 provides storage space for carts, coffee makers, food, multiple standard units and other items. The galley monument assembly 10 includes a lower storage section 14 and an upper storage section 20 that includes an overhanging portion 16 that is secured to the overhead stowage bin 12. As is shown in FIG. 10, the upper storage section 20 extends into the area that is typically used for overhead stowage compartment in an existing aircraft.

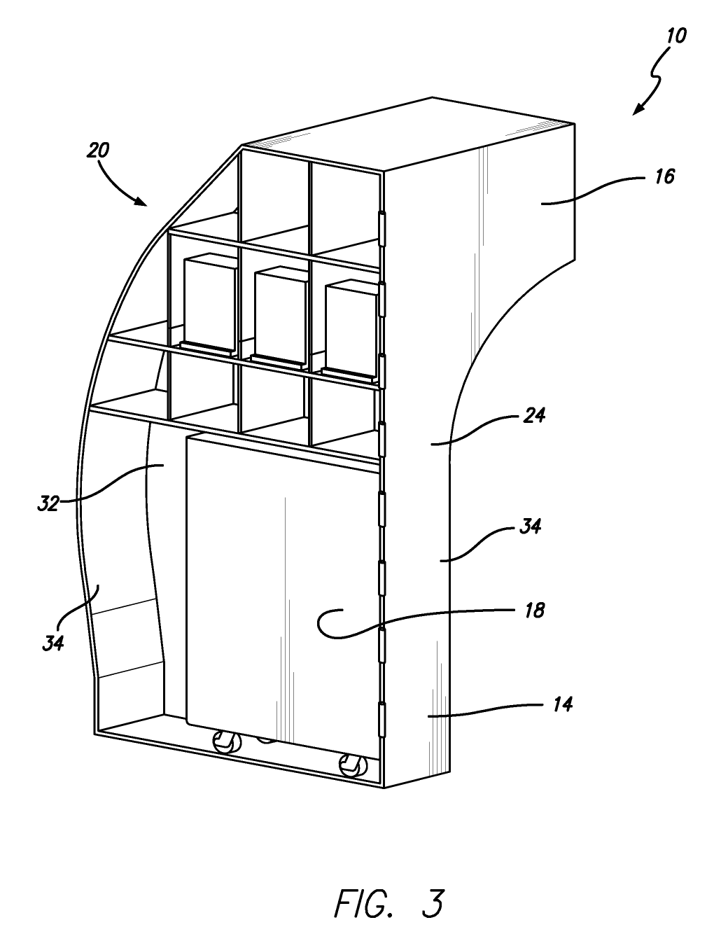

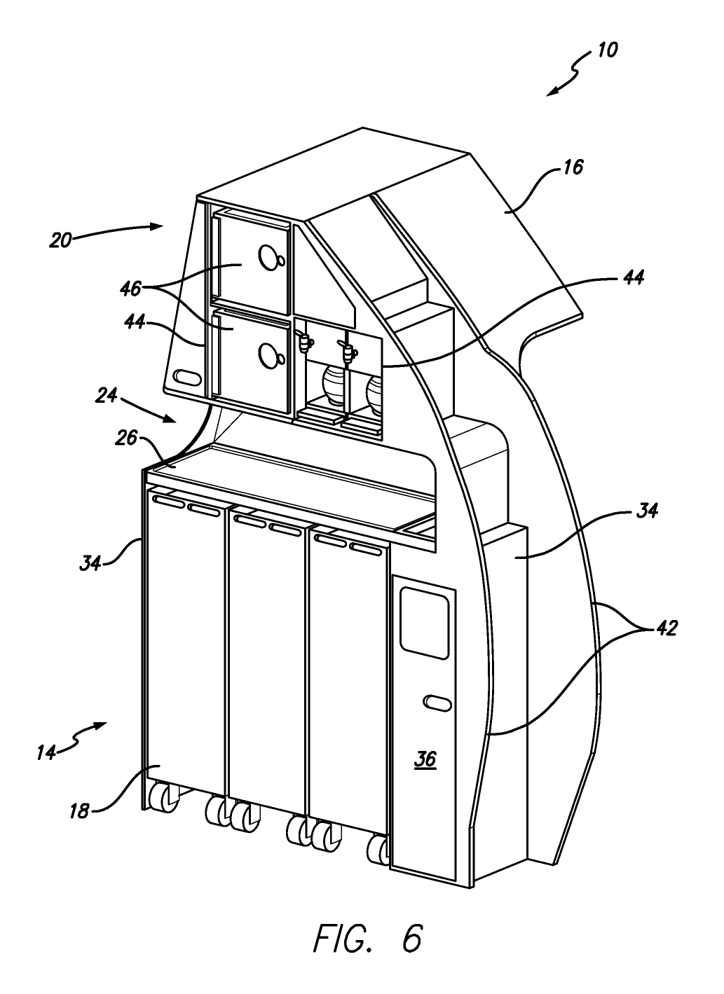

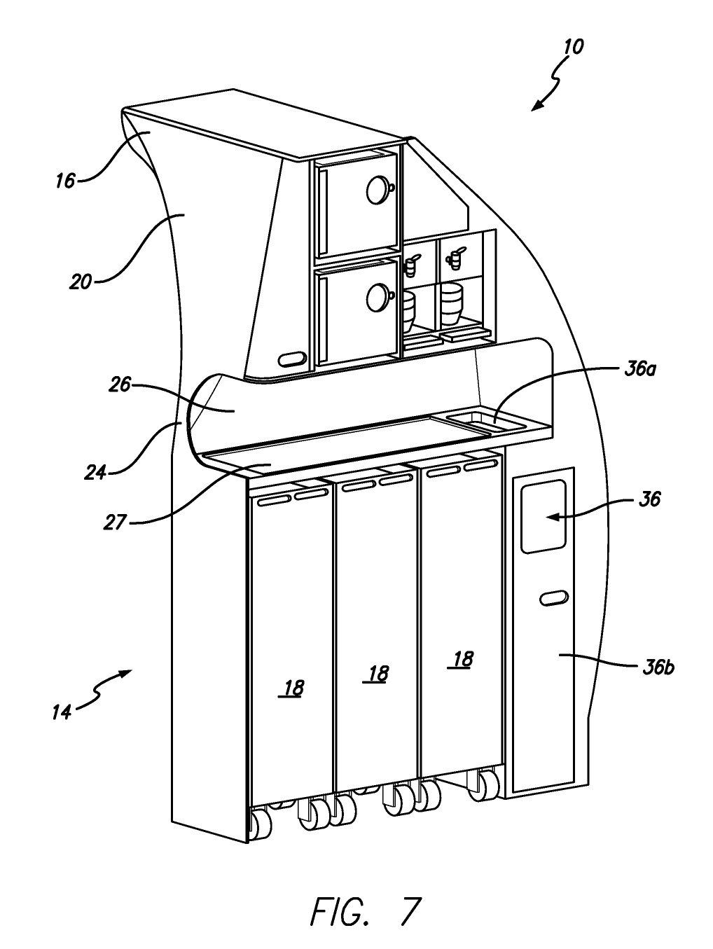

In a preferred embodiment, the galley monument assembly 10 is designed such that a standard aircraft seat 22 can be positioned below the overhanging portion 16, with preserved ergonomics for passengers (see FIG. 5). As shown in FIGS. 3 and 6 the galley monument assembly 10 is also sized so that at least one trolley cart 18 can be stowed and secured therein. FIG. 3 shows the trolley cart 18 stowed with a side facing aft. As shown in FIGS. 6 and 7, in another embodiment, the storage space can be deep enough to stow the trolley cart 18 with the front or back facing aft. The stowed trolley cart 18 is secured to the galley in a way such that the trolley cart 18 can be pulled out. In another embodiment, their can be a door 48 on the side of the galley monument assembly 10 for inserting or removing the trolley cart 18 (see FIG. 11). Standard quarter-turn locking mechanisms can be used to secure the trolley carts 18 to the galley monument assembly 10.

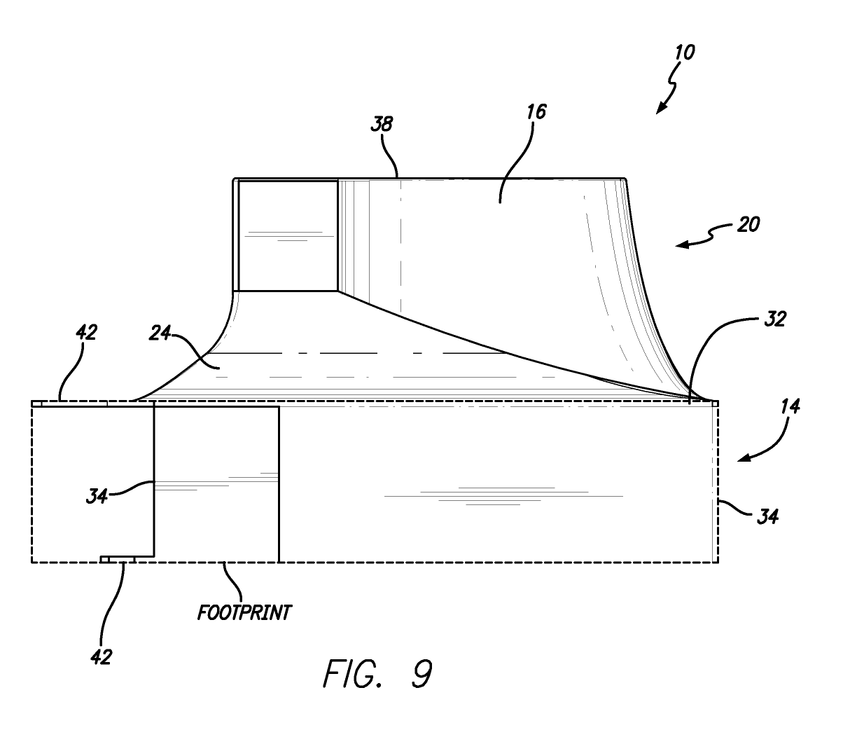

As discussed above, in a preferred embodiment, some of the space typically used for overhead stowage is utilized to increase the storage space of the galley monument assembly 10, and, in particular, the upper storage section 20. This provides more space for stowage when compared to a standard galley monument, while preserving the small footprint that is the same or similar to that of a standard galley monument. Floor space in an aircraft of is important. Therefore, a small floor footprint is desirable. FIG. 9 shows the floor footprint defined by the galley monument assembly 10.

As shown in FIGS. 5-7, in a preferred embodiment, the galley monument assembly 10 is adapted to have at least one (and preferably a plurality of) trolley carts 18 in the lower storage section 14 and dividers/walls that define compartments 44 for inserts 46 and containers in the upper storage section 20. The compartments include a front opening 44a. In a preferred embodiment, the galley monument assembly 10 includes a transition section 24 disposed between the upper storage section 20 and lower storage section 14. As shown in FIGS. 6-7, in a preferred embodiment, the transition section 24 includes a work space 26 and work surface 27 that can be used by flight attendants during flight or for other uses. In another embodiment, and as shown in FIG. 3, the transition section 24 can include more storage space and the work space can be omitted.

In a preferred embodiment, the lower storage section 14 includes a vertically oriented rear wall 32, two opposing side walls 34 and an open front that the trolley carts 18 can be inserted therein. In an embodiment, the lower storage section 14 can also include a trash compartment 36 or the like with an opening 36a and door 36b therefor. In another embodiment, the volume taken up by the trash compartment can be replaced with further storage area for trolley carts 18. The galley monument assembly 10 also preferably includes flanges 42 that extend outboard and are shaped to abut the inside wall of the aircraft 100.

As shown in FIG. 5, the lower storage section 14 defines a first storage depth D1 and the upper storage section 20 defines a second storage depth D2. In a preferred embodiment, the second storage depth D2 extends from the front of the monument to rear wall 38 without any obstacles. Due to the overhanging portion 16, the second storage depth D2 is deeper than the first storage depth D1. The second storage depth D2 preferably extends to the rear wall 38 of the overhanging portion, which abuts an end wall of the overhead stowage bin 12 (shown as a box in FIGS. 5 and 11). As used herein, abut means that the rear wall 38 can be touching or closely adjacent to the wall of the overhead stowage bin. And, if the rear wall 38 and wall of the overhead stowage bin are touching, they may or may not be attached to one another. Furthermore, the transition section 24 defines a gradually increasing third storage depth. The third storage depth D3 is represented in FIGS. 5 and 11 with a single arrow. However, it will be appreciated that the entire transition section 24 of the galley monument assembly 10 includes increasing storage space. In a preferred embodiment, the first storage depth D1 is approximately the same size as the depth of the floor footprint of the galley monument assembly 10 (minus the thickness of rear wall 32).

As is best shown in FIG. 5, in a preferred embodiment, at least a portion of the upper storage section 20 extends horizontally either all or forward, depending on galley location, and over the seating area. FIG. 5 shows the galley monument assembly 10 positioned behind a seat 22 (or row of seats). However, the galley monument assembly 10 can also be positioned in front of the seats. A seat or row of seats 22 (that each include a seat portion 28 and a back portion 30) are positioned adjacent the rear wall 32 of the lower storage section 14. As shown in FIG. 5, at least a portion of the upper storage section 20 (the overhanging portion 16) is positioned vertically above at least a portion of the back portion 30 of the seat 22. In another embodiment, the overhanging portion 16 can extend further horizontally. In an embodiment where the galley monument assembly 10 is positioned in front of a row of seats 22, the overhanging portion 16 upper storage section 20 (the overhanging portion 16) is positioned vertically above at least a portion of the seat portion 28 of the seat 22. In other words, when a passenger is seated in seat 22, storage space from the galley monument assembly 10 will be positioned vertically above the passenger.

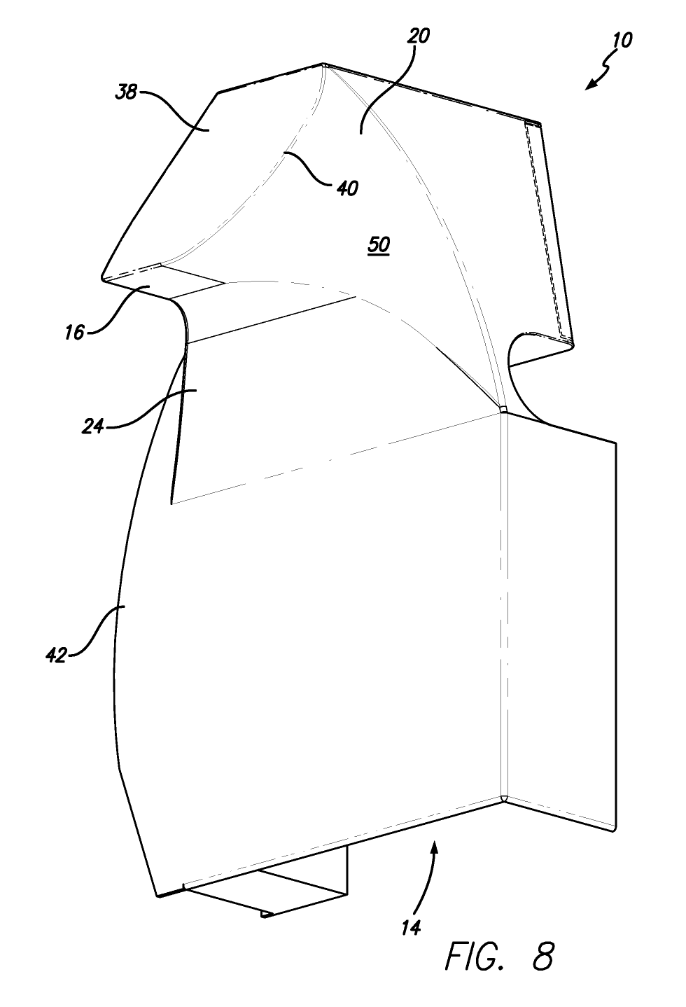

As is shown in FIG. 8, in a preferred embodiment, the overhanging portion 16 includes a rear wall 38 that has a contoured inboard edge 40 that abuts and approximates the inboard edge of the overhead stowage bin 12 (not shown in FIG. 8). In a preferred embodiment, the rear wall 38 of the overhanging portion 16 and the side wall of the overhead stowage bin 12 have approximately the same shape. In a preferred embodiment, the galley monument assembly 10 includes a transition surface 50 to transition between the overhanging portion 16 and the overhead stowage bin 12 to the rear wall 32. Between the transition surface 50 and contoured inboard edge 40, the overhanging portion 16 and the storage compartment therein blend the overhead stowage bin 12. However, this is not a limitation on the present invention.

The galley monument assembly 10 can be used in an aircraft with an integrated lavatory galley monument as is taught in U.S. Patent App. No. 61/598,774 and simultaneously filed U.S. patent application Ser. No. 13/765,396 titled Integrated Lavatory Galley Monument naming inventors Kyle Gee, Marisa Ouchi, Nicholas Lee and Scott Savian. The integrated lavatory galley monument includes a central galley and two dual outer lavatories (see FIG. 11). In many standard aircrafts, the aft galley fits six carts. In a preferred embodiment of the integrated lavatory galley monument, the galley fits four carts. When combined with two galley monument assemblies 10 of the present invention, which each hold one cart or more the two inventions hold six carts or more while providing extra room that can be used to add seats.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

The teachings of the disclosure provided herein can be applied to other systems, not necessarily the system described above. The elements and acts of the various embodiments described above can be combined to provide further embodiments. Any measurements described or used herein are merely exemplary and not a limitation on the present invention. Other measurements can be used.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will include the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A galley monument assembly configured to be positioned in the interior of an aircraft, the galley monument assembly comprising:
a lower storage section that is adapted to receive at least one trolley cart, the lower storage section including a vertically oriented rear wall and two opposing side walls, wherein the lower storage section defines a first storage depth, and
an upper storage section, wherein the upper storage section defines a second storage depth, wherein the second storage depth is deeper than the first storage depth.

2. The galley monument assembly of claim 1 further comprising a floor footprint that defines a depth, wherein the depth of the upper storage section is greater than the depth of the floor footprint.

3. The galley monument assembly of claim 2 further comprising a transition section disposed between the lower storage section and the upper storage section, wherein the transition section defines a gradually increasing storage depth.

4. The galley monument assembly of claim 3 wherein the gradually increasing storage depth is greater than the depth of the floor footprint.

5. The galley monument assembly of claim 4 further comprising an overhanging portion that defines at least a portion of the upper storage section and that includes a rear wall that has a contoured inboard edge, wherein when the galley monument assembly is positioned in the interior of an aircraft, the rear wall abuts a wall of an overhead stowage bin and the contoured inboard edge has approximately the same shape as an inboard edge of the wall of the overhead stowage bin.

6. The galley monument assembly of claim 5 further comprising a work surface that separates the lower storage area and the transition section.

7. An aircraft comprising
a cabin having an interior side wall,
at least a first overhead stowage bin having an end wall, wherein the first overhead stowage bin is positioned within the cabin and attached to the interior side wall,
a galley monument assembly positioned within the cabin, wherein the galley monument assembly includes a lower storage section that is adapted to receive at least one trolley cart, the lower storage section including a vertically oriented rear wall and two opposing side walls, wherein the lower storage section defines a first storage depth, an upper storage section that defines a second storage depth, wherein the second storage depth is deeper than the first storage depth, and wherein the upper storage section includes a rear wall that abuts the end wall of the first overhead stowage bin.

8. The aircraft of claim 7 wherein the galley monument assembly further comprises a transition section disposed between the lower storage section and the upper storage section, wherein the transition section defines a gradually increasing storage depth.

9. The aircraft of claim 8 further comprising at least one seat positioned adjacent the rear wall of the lower storage section of the galley monument, wherein the seat includes a seat portion and a back portion, wherein at least a portion of the upper storage section is positioned vertically above one or both of the back portion or the seat portion.

10. The aircraft of claim 9 wherein the galley monument assembly includes an overhanging portion that at least partially defines the upper storage section, wherein the overhanging portion includes a rear wall that has a contoured inboard edge with a shape, wherein the end wall of the first overhead storage bin has an inboard edge with a shape, and wherein the contoured inboard edge has approximately the same shape as the inboard edge of the end wall of the overhead stowage bin.

11. The aircraft of claim 10 wherein the galley monument assembly includes a floor footprint that defines a depth, wherein the depth of the upper storage section and the gradually increasing storage depth are each greater than the depth of the floor footprint.

12. A method comprising the steps of:
positioning within the cabin of an aircraft at least a first overhead stowage bin having an end wall,
positioning within the cabin of the aircraft a galley monument assembly that includes a lower storage section that is adapted to receive at least one trolley cart, the lower storage section including a vertically oriented rear wall and two opposing side walls, wherein the lower storage section defines a first storage depth, an upper storage section that defines a second storage depth and that includes at least a first compartment having a front opening, wherein the second storage depth is deeper than the first storage depth, and when the upper storage section includes a rear wall that abuts the end wall of the first overhead stowage bin,
positioning at least one seat adjacent the rear wall of the lower storage section of the galley monument, wherein the seat includes a seat portion and a back portion, wherein at least a portion of the upper storage section is positioned vertically above one or both of the back portion or the seat portion,
placing a first object into the upper storage section through the front opening of the first compartment, and
pushing the object through the first compartment to a position where it is located vertically above one or both of the back portion or the seat portion.

13. The method of claim 12 wherein the galley monument assembly further comprises a transition section disposed between the lower storage section and the upper storage section, wherein the transition section defines a gradually increasing storage depth and includes at least a second compartment having a front opening.

14. The method of claim 13 further comprising the steps of
placing a second object into the transition section through the front opening of the second compartment, and
pushing the object through the second compartment to a position where it is located deeper than the first storage depth.
